(19) United States
(12) Patent Application Publication
(10) Pub. No.: US 2003/0035383 A1
(43) Pub. Date: Feb. 20, 2003

(54) Method, system and computer program product for bandwidth-on-demand signaling

(76) Inventor: Stephen Hershey, Gaithersburg, MD (US)

Correspondence Address: Hughes Electronics Corporation, Patent Docket Administration, P.O. Box 956, Bldg. 1, Mail Stop A109, El Segundo, CA, 90245-0956, US

(21) Appl. No.: 09/963,352

(22) Filed: Sep. 26, 2001

Related U.S. Application Data
(60) Provisional application No. 60/310,591, filed on Aug. 7, 2001.

(51) Int. Cl. H04B 1/44

(52) U.S. Cl. 370/282; 370/386

(57) ABSTRACT

A computer-implemented method, system and computer program product for demanding a data link resource in a communications network, including calculating an unsatisfied demand (UD) value for the data link resource at a terminal and transmitting the calculated UD value over the data link from the terminal to a base station at a time uncorrelated with a time at which new demand for the data link resource is detected by the terminal. The UD value is calculated as UD=NUM_RLC_BLK_UNSENT+NUM_RLC_BLK_NACK, where NUM_RLC_BLK_UNSENT is a number of radio link control (RLC) blocks not yet sent and NUM_RLC_BLK_NACK is a number of RLC blocks negatively acknowledged by the base station. The UD value is received from the terminal at the base station over the data link. The base station calculates an imputed unsatisfied demand (IUD) value based on the received UD value and existing data link resources already allocated to the terminal and transmits the calculated IUD value to a data link resource scheduler.

### CROSS REFERENCE TO RELATED DOCUMENTS

The present invention claims the benefit of priority under 35 U.S.C. § 119(e) to U.S. Provisional Patent Application No. 60/XXX,XXX of Hershey, entitled “GMPRS BANDWIDTH-ON-DEMAND SIGNALING,” filed on Aug. 7, 2001 and includes use of various technologies described in the references identified in the appended LIST OF REFERENCES and cross-referenced throughout the specification by numerals in brackets corresponding to the respective references, the entire contents of all of which are incorporated by reference herein.

### FIELD OF THE INVENTION

The present invention generally relates to communications and more particularly to a method, device and computer program product for providing bandwidth-on-demand signaling in a communications network.

### DISCUSSION OF THE BACKGROUND

As the percentage of communications traffic consisting of data increases with each passing year, the deployment of wired and wireless networks capable of efficiently transporting data increases in importance. A key characteristic of data traffic is large fluctuation in instantaneous demand for network resource (often called burstiness). bandwidth-on-demand (BOD) scheduling strategies are designed to make efficient use of data link resources while transporting bursty data between terminals and a base station. A bandwidth-on-demand strategy is more efficient than a periodic allocation scheme because the allocation of data link resources to a terminal is tailored to the immediate resource requirement of the terminal.

In previous approaches to BOD signaling, a terminal indicates its current demand for data link resource only when this demand changes. Such a change in demand usually occurs after new network protocol data units (PDUs) [1] arrive in the data link layer of the terminal and await transport to the base station. The request for additional data link resource therefore typically occurs intermittently on an “as needed” basis and is dependent upon the detection of new demand for data link resources by the terminal's data link layer. This approach has several disadvantages. First, a protocol must be deployed and tested to detect when a message from the terminal requesting additional data link resource is lost. This protocol, although simple in theory, can be quite complicated to implement and thoroughly test in practice. Second, the time required to successfully retransmit a request for additional data link resources can be unacceptably long over links with long propagation delays (e.g., such as in satellite links).

One approach, ALOHA (Basic, Slotted) [3], is a contention-based data link resource management scheme. However, there is no central scheduler and thus no signaling of additional resource demand by a terminal is possible.

Another approach, the General Packet Radio Service (GPRS) [4], employs a Countdown field within the header of every Medium Access Control (MAC) [8] block sent from a terminal to a base station. However, the Countdown field is not intended to signal the arrival of new, unsatisfied demand for data link resources to the base station. Instead, the Countdown field is intended to communicate the exact Block Sequence Number (BSN) of the final Radio Link Control (RLC) block within a flow, so the base station can terminate the flow cleanly.

Another approach, the Broadband Radio Access Networks (BRAN) [5] data link protocol, employs a Resource Request/Resource Grant scheme. The Resource Request message sent by a terminal indicates whether the request is an initial attempt or a retransmission. The Resource Request message is, however, sent on an “as needed” basis by a terminal, resulting in disadvantages, as previously discussed.

Another approach, the TErrestrial Trunked RAdio (TETRA) Packet Data Optimized (PDO) [6] data link protocol, also employs a Resource Request/Resource Grant scheme. However, an existing resource grant must be completely satisfied before a new resource request can be made by a terminal, resulting in disadvantages, as previously discussed.

Another approach, the UMTS [7] data link protocol, does not employ unsatisfied demand signaling, resulting in disadvantages, as previously discussed.

Therefore, there is a need for a method, system and computer program product for improving bandwidth-on-demand signaling to support the deployment of bandwidth-on-demand schedulers in packet data communications networks, such as satellite networks, etc.

### SUMMARY OF THE INVENTION

The above and other needs are addressed by the present invention, which provides an improved method, system and computer program product for providing bandwidth-on-demand signaling in a communications network.

Accordingly, in one aspect of the present invention there is provided a computer-implemented method, system and computer program product for demanding a data link resource in a communications network, including calculating an unsatisfied demand (UD) value for the data link resource at a terminal; and transmitting the calculated UD value over the data link from the terminal to a base station at a time uncorrelated with a time at which new demand for the data link resource is detected by the terminal.

In another aspect of the present invention, there is provided a computer-implemented method, system and computer program product for demanding a data link resource in a communications network, including calculating an unsatisfied demand (UD) value for the data link resource at a terminal, based on the following equation:

UD=NUM_RLC_BLK_UNSENT+NUM_RLC_BLK_NACK,

where NUM_RLC_BLK_UNSENT is a number of radio link control (RLC) blocks not yet sent and NUM_RLC_BLK_NACK is a number of RLC blocks negatively acknowledged by a base station; and transmitting the calculated UD value over the data link from the terminal to the base station.

In another aspect of the present invention, there is provided a computer-implemented method, system and computer program product for interpreting a demand for a data link resource in a communications network, including calculating at a terminal an unsatisfied demand (UD) value for the data link resource based on the following equation:

UD=NUM_RLC_BLK_UNSENT+NUM_RLC_BLK_NACK,

where NUM_RLC_BLK_UNSENT is a number of radio link control (RLC) blocks not yet sent and NUM_RLC_BLK_NACK is a number of RLC blocks negatively acknowledged by a base station; transmitting the calculated UD value over the data link from the terminal to the base station; receiving the UD value for the data link resource from the terminal at the base station over the data link; calculating an imputed unsatisfied demand (IUD) value at the base station based on the received UD value and existing data link resources already allocated to the terminal; and transmitting the calculated IUD value to a data link resource scheduler.

In another aspect of the present invention, there is provided a computer-implemented method, system and computer program product for performing bandwidth-on-demand signaling in a communications network, including calculating at a terminal an unsatisfied demand (UD) value for a data link resource based on the following equation:

UD=NUM_RLC_BLK_UNSENT+NUM_RLC_BLK_NACK,

where NUM_RLC_BLK_UNSENT is a number of radio link control (RLC) blocks not yet sent and NUM_RLC_BLK_NACK is a number of RLC blocks negatively acknowledged by a base station; transmitting the calculated UD value over the data link from the terminal to the base station at a time uncorrelated with a time at which new demand for the data link resource is detected by the terminal; receiving the UD value for the data link resource from the terminal at the base station over the data link; calculating an imputed unsatisfied demand (IUD) value at the base station based on the received UD value and existing data link resources already allocated to the terminal; and transmitting the calculated IUD value to a data link resource scheduler.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a system diagram illustrating an exemplary system, which may employ bandwidth-on-demand signaling, according to the present invention;

FIGS. 2a-2e are flow charts illustrating bandwidth-on-demand signaling in the system of FIG. 1, according to the present invention;

FIG. 3 is as state diagram illustrating bandwidth-on-demand signaling in the system of FIG. 1, according to the present invention; and

FIG. 4 is an exemplary computer system, which may be programmed to perform one or more of the processes of the present invention.

### DETAILED DESCRIPTION OF THE PREFERRED EMBODIMENTS

A method, system and computer program product for providing bandwidth-on-demand (BOD) signaling in a communications network, are described. In the following description, for purposes of explanation, numerous specific details are set forth in order to provide a thorough understanding of the present invention. It is apparent to one skilled in the art, however, that the present invention may be practiced without these specific details or with an equivalent arrangement. In some instances, well-known structures and devices are shown in block diagram form in order to avoid unnecessarily obscuring the present invention.

The present invention includes recognition of and overcomes the disadvantages of the previous approaches, such as discussed in the “DISCUSSION OF THE BACKGROUND,” by enabling each terminal to send its current demand for data link resource with predetermined transmissions (e.g., on every transmission from the terminal to the base station over the data link, on every transmission in which data is transmitted from the terminal to the base station over the data link, etc.). If a certain terminal data transmission indicating a request for additional data link resource is lost, then no special action is taken by the terminal or base station because the next predetermined terminal transmission will convey the same information. The General Mobile Packet Radio Service (GMPRS) Bandwidth-on-Demand (BOD) Signaling System, according to the present invention, thus, enables the deployment of highly capable BOD schedulers while adding little complexity to the peer-to-peer data link protocol.

In addition, the present invention includes recognition that there is a difference between the purpose and use of the GPRS Countdown field, as discussed in the “DISCUSSION OF THE BACKGROUND” and the GMPRS Unsatisfied Demand (UD) field, as further described herein. In contrast to the GMPRS Unsatisfied Demand field, the GPRS Countdown field is not intended to support bandwidth-on-demand operations during a flow, but merely support the flow release procedure. In addition, the GMPRS Unsatisfied Demand field, advantageously, performs the same function as the GPRS Countdown field during flow release and additionally supports bandwidth-on-demand scheduling during flow operation.

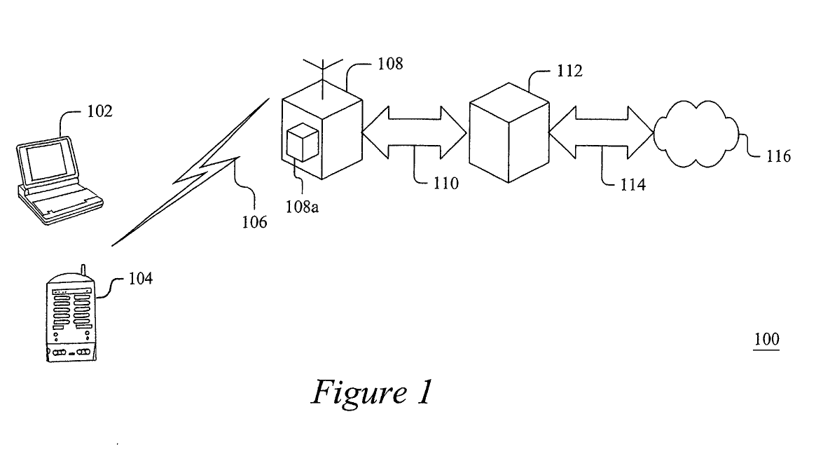

Referring now to the drawings, wherein like reference numerals designate identical or corresponding parts throughout the several views, and more particularly to FIG. 1 thereof, there is illustrated a system 100, which may employ bandwidth-on-demand signaling, according to the present invention. In FIG. 1, the system 100 includes one or more wireless terminals 102 and 104 coupled to a base station 108, including a data link resource scheduler 108a, via data link 106. One or more base stations 108 may be coupled to a gateway 112 via communications channel 110. The gateway 112 may be coupled to a communications network 116 (e.g., Public Switched Telephone Network (PSTN) [11], Integrated Services Digital Network (ISDN) [12], Packet Data Network (PDN) [13], etc.) via communications channel 114.

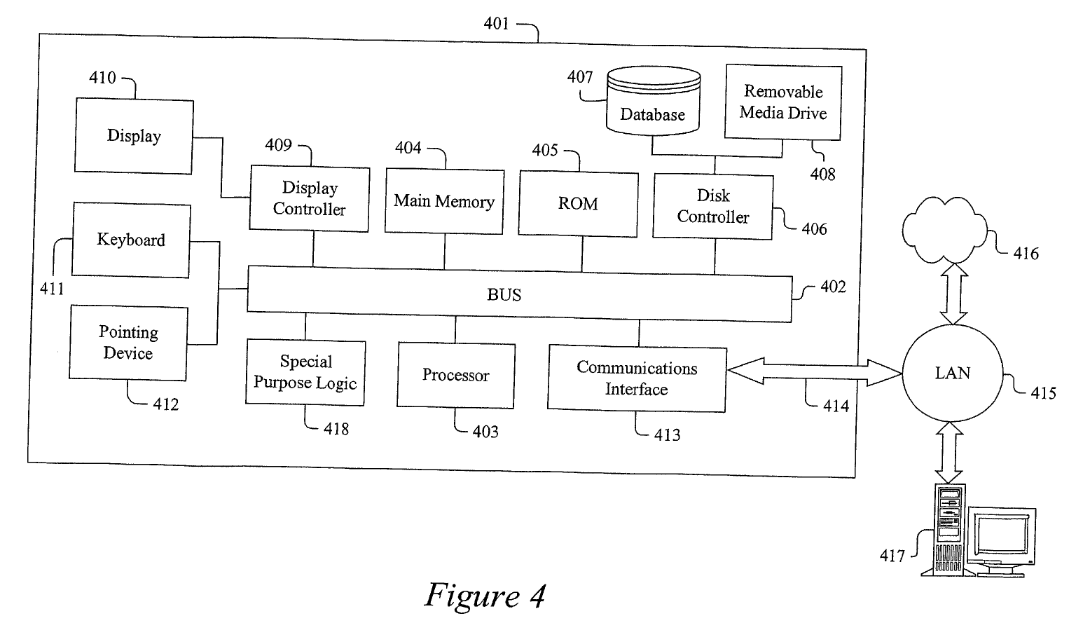

The terminals 102 and 104, the base station 108 and the gateway 112 of system 100 may include any suitable servers, workstations, personal computers (PCs), personal digital assistants (PDAs), Internet appliances, set top boxes, other devices, etc., capable of performing the processes of the present invention. The terminals 102 and 104, the base station 108 and the gateway 112 of the system 100 may communicate with each other using any suitable protocol, for example, via the data link 106 and the communications channels 110 and 114 and may be implemented using the computer system 401 of FIG. 4, for example. One or more interface mechanisms may be used in the system 100, for example, including Internet access, telecommunications in any form (e.g., voice, modem, etc.), wireless communications media, etc., via the data link 106 and the communications channels 110 and 114. Accordingly, the data link 106, the communications channels 110 and 114 and the communications network 116 may include, for example, the Internet, an Intranet, wireless communications, satellite communications, cellular communications, hybrid communications, etc.

If the system 100 is implemented as a satellite communications system, the base station 108 may be provided in the satellite and the data link 106 and the communications channel 110 would perform satellite communications. The present invention is also applicable to, for example, GPRS communications systems, the Global System for Mobile Communications (GSM) [10], any packet data applications employing a centralized data link resource scheduler, etc., as will be appreciated by those skilled in the relevant art(s).

It is to be understood that the system in FIG. 1 is for exemplary purposes only, as many variations of the specific hardware used to implement the present invention are possible, as will be appreciated by those skilled in the relevant art(s). For example, the functionality of the terminals 102 and 104, the base station 108 and the gateway 112 of the system 100 may be implemented via one or more programmed computers or devices. To implement such variations as well as other variations, a single computer (e.g., the computer system 401 of FIG. 4) may be programmed to perform the special purpose functions of, for example, the base station 108 and the gateway 112 shown in FIG. 1. On the other hand, two or more programmed computers or devices, for example as in shown FIG. 4, may be substituted for any one of the terminals 102 and 104, the base station 108 and the gateway 112. Principles and advantages of distributed processing, such as redundancy, replication, etc., may also be implemented as desired to increase the robustness and performance of the system 100, for example.

The data link 106 and the communications channels 110 and 114 may be implemented via one or more communications channels (e.g., the Internet, an Intranet, a wireless communications channel, a satellite communications channel, a cellular communications channel, a hybrid communications channel, etc.), as will be appreciated by those skilled in the relevant art(s). In a preferred embodiment of the present invention, the data link 106 and the communications channels 110 and 114 preferably uses electrical, electromagnetic, optical signals, etc., that carry digital data streams, as are further described with respect to FIG. 4.

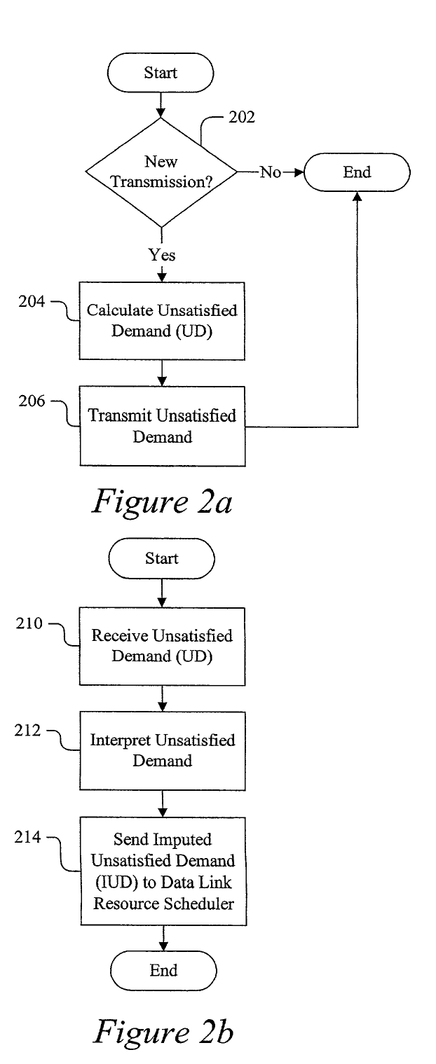

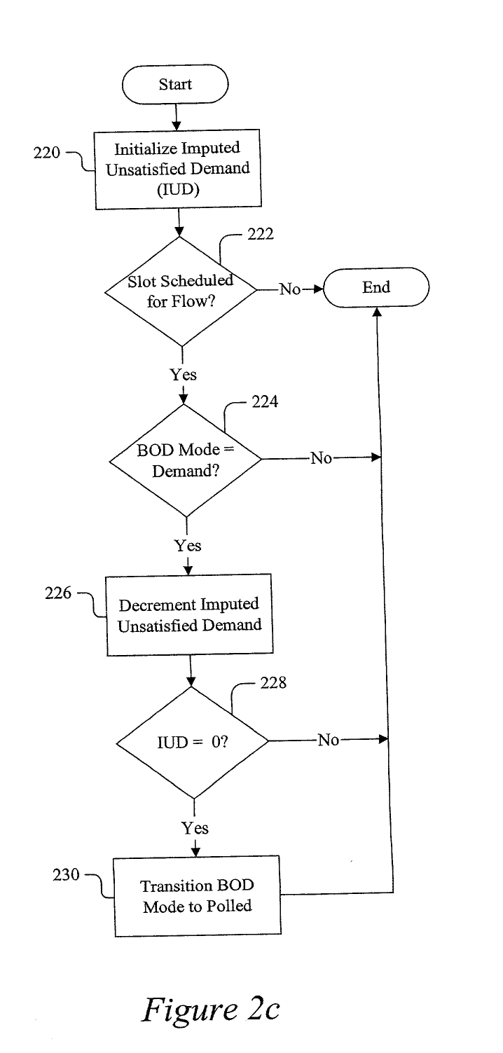

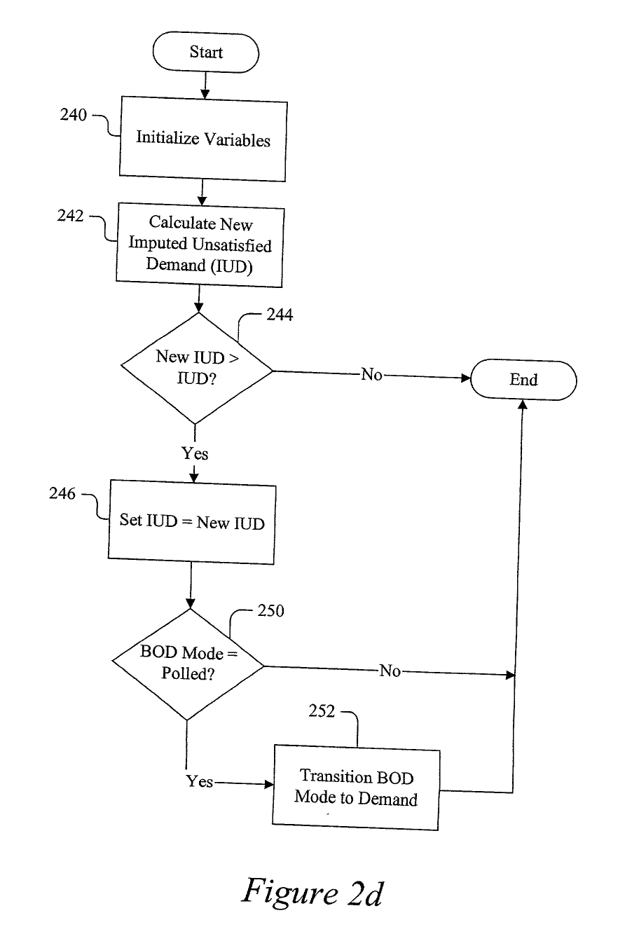

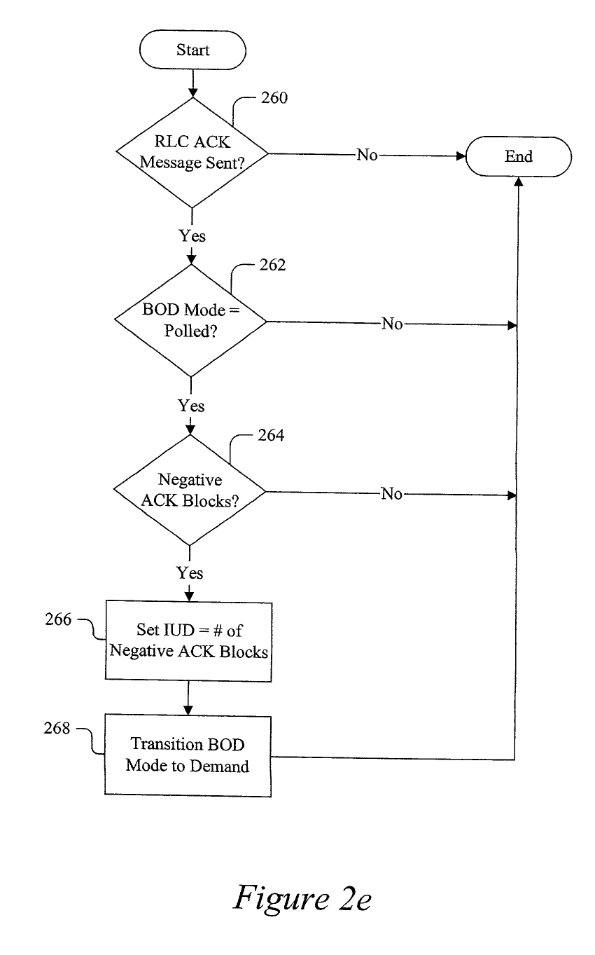

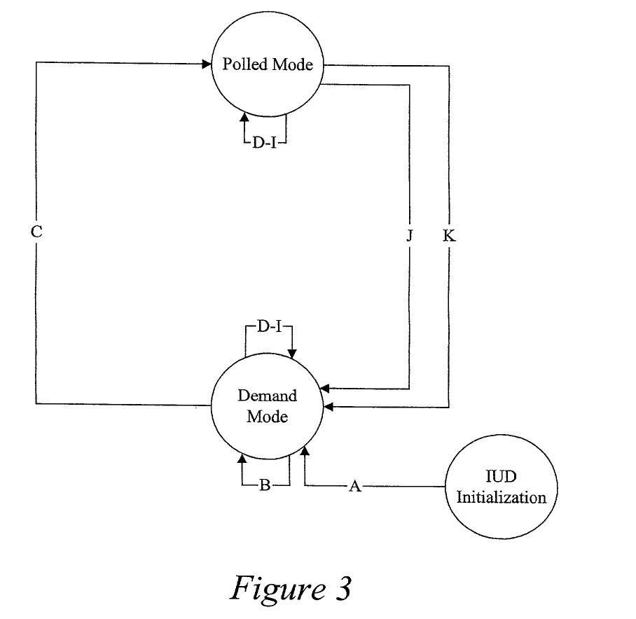

FIGS. 2a-2e are flow charts and FIG. 3 is as state diagram for illustrating bandwidth-on-demand signaling in the system of FIG. 1, according to the present invention. The various processes preformed by the present invention will now be further described with reference to FIGS. 2-3.

The General Mobile Packet Radio Service (GMPRS) bandwidth-on-demand (BOD) signaling system, according to the present invention, for example, includes processes by which the terminals 102 and 104 generate a demand for the data link 106 resources, processes by which the terminals 102 and 104 communicate the demand to the base station 108 and processes by which the base station 108 interprets the demand for data link 106 resources received from the terminals 102 and 104. These and other processes according to the present invention provide a novel approach to supporting a bandwidth-on-demand (BOD) signaling capability in the network consisting of multiple terminals 102 and 104 and the base station 108 employing the central resource scheduler 108a, as shown in the system 100 of FIG. 1.

As shown in FIG. 2a, the basic concept is that the terminal 102 or 104 calculates its additional need for data link resource (referred to as “unsatisfied demand” UD) prior to a transmission to the base station (e.g., on every transmission from the terminal 102 or 104 to the base station 108 over the data link 106, on every transmission in which data is transmitted from the terminal 102 or 104 to the base station 108 over the data link 106, etc, steps 202-204). The unsatisfied demand calculation includes both pending new transmissions and pending retransmissions. The terminal 102 or 104 includes its current unsatisfied demand (UD) in such predetermined transmissions to the base station 108 (step 206). As shown in FIG. 2b, after receiving the unsatisfied demand indication from the terminal 102 or 104 (step 210), the base station 108 interprets the received unsatisfied demand indication in light of existing allocations already made to the terminal 102 or 104 (step 212). The base station 108 then sends the net unsatisfied demand (referred to as “imputed unsatisfied demand” IUD) of the terminal 102 or 104 to the data link resource scheduler 108a of the base station 108 (step 214).

The GMPRS bandwidth-on-demand (BOD) signaling system according to the present invention supplies a peer-to-peer signaling mechanism and associated procedures in order to support bandwidth-on-demand scheduling over an unreliable link with long propagation delays (e.g., such as a satellite communications link, etc.).

The GMPRS BOD signaling system includes a network topology where the base station (BS) 108 arbitrates access to data link 106 resources shared by multiple terminals 102 and 104. In the present invention, the BS 108 allocates a unit of data link 106 resource (i.e., a slot) for the exclusive use of the particular terminal 102 or 104 by sending a resource allocation message in the downlink direction of the data link 106 to the terminal 102 or 104. The terminal 102 or 104 uses an allocated slot to send a Medium Access Control (MAC) [8] block in the uplink direction to the BS 108. The MAC block contains a header with signaling information and a Radio Link Control (RLC) block or control message. The RLC block is a contiguous series of bytes extracted from a network-level protocol data unit (PDU), such as an IP datagram [9]. An algorithm called the uplink slot scheduler 108a (e.g., implemented via software and/or hardware, etc.) running on the BS 108 dynamically allocates slots to particular terminals 102 or 104 based upon current data link resource requirements of the terminals 102 or 104. In the present invention, the terminals 102 or 104 support one or more independent data streams called flows. Each flow is composed of multiple network PDUs and has unique and rapidly changing data link 106 resource demands.

The GMPRS BOD signaling system is a novel technique for generating, signaling, and interpreting data link 106 resource demands. The present invention includes, for example, the procedure in the terminal 102 or 104 that generates the data 106 link resource demand indication and sends the resource demand to the BS 108. The present invention also includes, for example, the BS 108 procedure that interprets the resource demand indication. The BS 108 uplink slot scheduling algorithm 108a that allocates particular slots to particular flows may be implemented in ways known in the art using software and/or hardware. The GMPRS BOD signaling system supplies the uplink slot scheduler 108a with instantaneous demand for data link 106 resources for each flow. The uplink slot scheduler 108a uses this information to allocate uplink data link 106 resources to the uplink flows in ways known in the art.

Mobile Terminal 102 or 104 Support for the GMPRS BOD Signaling System

The GMPRS terminal 102 or 104 calculates a value for the Unsatisfied Demand (UD) field in the MAC header of a transmitted MAC block (e.g., on every transmission of a MAC block from the terminal 102 or 104 to the base station 108 over the data link 106, on every transmission of a MAC block in which an RLC block is transmitted from the terminal 102 or 104 to the base station 108 over the data link 106, etc.). The UD field indicates the additional uplink data link 106 resource required by the flow, as measured in RLC blocks. The UD field is determined, for example, by the following equation:

UD=NUM_RLC_BLK_UNSENT+NUM_RLC_BLK_NACK

where NUM_RLC_BLK_UNSENT is the number of RLC blocks not yet sent (i.e., awaiting first transmission), NUM_RLC_BLK_NACK is the number of RLC blocks negatively acknowledged by the base station 108 (i.e., awaiting retransmission) and UD_MAX is the maximum unsatisfied demand that can be conveyed by the UD field of the MAC header. If UD is greater than UD_MAX, then UD is set to UD_MAX. The BS 108 interprets a received UD of UD_MAX as “UD_MAX or more RLC blocks pending for the flow.”

Base Station 108 Support for the GMPRS BOD Signaling System

Scheduler 108a Operating Modes

The BS 108 considers each uplink flow to be in, for example, one of two modes: DEMAND or POLLED. In DEMAND mode, the BS 108 fulfills previously signaled known unsatisfied demand. In POLLED mode, the BS 108 allocates unsolicited uplink slots to the terminal 102 or 104 to determine if the terminal 102 or 104 has new unsatisfied demand for the data link 106 resource. When the BS 108 receives an uplink MAC block containing an RLC block and with UD greater than zero for a flow in POLLED mode, the BS 108 transitions the uplink flow to DEMAND mode and begins servicing the known demand.

Imputed Unsatisfied Demand (IUD)

The BS 108 must interpret each UD indication received from the terminal 102 or 104 in light of the uplink slot assignments already made for the uplink flow. For this purpose, the BS 108 maintains an internal estimate of the current unsatisfied demand (referred to as “imputed unsatisfied demand” IUD) of the uplink flow.

IUD Initialization

As shown in the flow chart of FIG. 2c and the state diagram of FIG. 3, the IUD variable is initialized to the initial unsatisfied demand signaled when the uplink flow is established (step 220, IUD initialization state). The BS 108 thus starts servicing a new flow in DEMAND mode (step A).

Lowering ID

The BS 108 decrements the IUD for a flow whenever an uplink slot is allocated for the flow in DEMAND mode (steps 222-226, step B). When IUD transitions to zero, the BS 108 transitions the flow from DEMAND mode to POLLED mode (steps 228-230, step C).

Example BS 108 pseudo-code for handling an uplink slot assignment:

If an uplink slot has been scheduled for a flow and the BOD mode is DEMAND

Decrement iud;
if iud is 0

transition the BOD mode of the flow to POLLED;

Raising IUD—UD Reception

As shown in the flow chart of FIG. 2d and the state diagram of FIG. 3, the BS 108 elevates the IUD for a flow whenever it receives an UD value indicating that the flow requires data link 106 resources that have not already been handled by previously allocated uplink slot assignments (steps 240-246, steps D-I). The BS 108 then transitions the BOD mode of the flow from POLLED to DEMAND and begins servicing the new unsatisfied demand (steps 250-252, step J).

Example BS 108 pseudo-code for handling a UD indication for a flow:

ud_new = UD signaled by the terminal 102 or 104 for an uplink flow;
iud = current IUD for the uplink flow;
iud_new = tentative new IUD for the uplink flow;
assign_out = assignments outstanding (i.e., the number of uplink slot assignments for

the flow transmitted by the BS 108 since the transmission of the uplink slot assignment that
resulted in the transmission of ud_new by the terminal 102 or 104);

bod_mode = current BOD mode of the flow (DEMAND or POLLED);
iud_new = ud_new − assign_out;
if(iud_new > iud)

iud = iud_new;
if bod_mode is POLLED

bod_mode is DEMAND;

Raising IUD—RLC Acknowledgement (ACK) Transmission

As shown in the flow chart of FIG. 2e and the state diagram of FIG. 3, to lower network PDU transfer delay, the BS 108 can prospectively raise the IUD for a flow whenever it sends an RLC Acknowledgement message negatively acknowledging one or more RLC blocks within the flow (steps 260-268, step K). The alternative method would be to wait until the terminal 102 or 103 receives the RLC Acknowledgement message, marks certain RLC blocks as negatively acknowledged, and then transmits the new UD value. Upon receipt of the new UD value, the BS 108 would then transition the flow to DEMAND mode and begin scheduling uplink slots for the RLC blocks to be retransmitted. However, prospectively elevating IUD by the number of negatively acknowledged RLC blocks in the RLC Acknowledgement message (step 266) as in the present invention, advantageously, eliminates the scheduling and signaling delays that result when the BS 108 waits for explicit notification via the UD field that the terminal 102 or 104 has received the RLC Acknowledgement message as in the alternative method.

Example BS pseudo-code for handling RLC Acknowledgement transmission:

bod_mode = current BOD mode of the flow (DEMAND or POLLED);
If BS sent an RLC ACK message for an uplink flow and bod_mode is POLLED and

there were RLC blocks negatively acknowledged by the RLC ACK message

iud = number of negatively acknowledged blocks in the RLC ACK message
bod_mode = DEMAND;

IUD Management Implementation Options

The BS 108 may prospectively elevate IUD after sending an RLC Acknowledgement message for a flow in DEMAND mode. However, RLC Acknowledgement messages sent within a short time of each other must not incorrectly elevate IUD to a high level. For example, if RLC Acknowledgement message #1 negatively acknowledges 50 RLC blocks and RLC Acknowledgement message #2 is sent a short time later and negatively acknowledges the same 50 RLC blocks, then it would be incorrect for the BS 108 to elevate IUD by 100 RLC blocks. The unsatisfied demand of the terminal 102 or 104 would only increase by 50 RLC blocks when the two RLC Acknowledgement messages are processed by the terminal 102 or 104, according to the present invention.

According to the present invention, the BS 108 may detect when the UD value signaled by the terminal 102 or 104 decreases by an amount impossible to explain by the uplink slot assignments made to the terminal 102 or 104. If such a drop in UD for a flow is permitted (e.g., the terminal 102 or 104 discards network PDUs not successfully transferred within a certain period, etc.), the BS 108 can lower ID accordingly. If such a drop in UD for a flow is not permitted, the BS 108 can log the error.

The present invention stores information relating to various processes described herein. This information is stored in one or more memories, such as a hard disk, optical disk, magneto-optical disk, RAM, etc. One or more databases, such as databases within the terminals 102 and 104, the base station 108, the gateway 112, etc., of the system 100, may store the information used to implement the present invention. The databases are organized using data structures (e.g., records, tables, arrays, fields, graphs, trees, and/or lists) contained in one or more memories, such as the memories listed above or any of the storage devices listed below in the discussion of FIG. 4, for example.

The previously described processes include appropriate data structures for storing data collected and/or generated by the processes of the system 100 of FIG. 1 in one or more databases thereof. Such data structures accordingly will includes fields for storing such collected and/or generated data. In a database management system, data is stored in one or more data containers, each container contains records, and the data within each record is organized into one or more fields. In relational database systems, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology. Systems that implement the present invention are not limited to any particular type of data container or database architecture. However, for the purpose of explanation, the terminology and examples used herein shall be that typically associated with relational databases. Thus, the terms “table,” “row,” and “column” shall be used herein to refer respectively to the data container, record, and field.

The present invention (e.g., as described with respect to FIGS. 1-3) may be implemented by the preparation of application-specific integrated circuits or by interconnecting an appropriate network of conventional component circuits, as will be appreciated by those skilled in the electrical art(s). In addition, all or a portion of the invention (e.g., as described with respect to FIGS. 1-3) may be conveniently implemented using one or more conventional general purpose computers, microprocessors, digital signal processors, micro-controllers, etc., programmed according to the teachings of the present invention (e.g., using the computer system of FIG. 4), as will be appreciated by those skilled in the computer and software art(s). Appropriate software can be readily prepared by programmers of ordinary skill based on the teachings of the present disclosure, as will be appreciated by those skilled in the software art. Further, the present invention may be implemented on the World Wide Web (e.g., using the computer system of FIG. 4).

FIG. 4 illustrates a computer system 401 upon which the present invention (e.g., the terminals 102 and 104, the base station 108, the gateway 112, the system 100, etc.) can be implemented. The present invention may be implemented on a single such computer system, or a collection of multiple such computer systems. The computer system 401 includes a bus 402 or other communication mechanism for communicating information, and a processor 403 coupled to the bus 402 for processing the information. The computer system 401 also includes a main memory 404, such as a random access memory (RAM), other dynamic storage device (e.g., dynamic RAM (DRAM), static RAM (SRAM), synchronous DRAM (SDRAM)), etc., coupled to the bus 402 for storing information and instructions to be executed by the processor 403. In addition, the main memory 404 can also be used for storing temporary variables or other intermediate information during the execution of instructions by the processor 403. The computer system 401 further includes a read only memory (ROM) 405 or other static storage device (e.g., programmable ROM (PROM), erasable PROM (EPROM), electrically erasable PROM (EEPROM), etc.) coupled to the bus 402 for storing static information and instructions.

The computer system 401 also includes a disk controller 406 coupled to the bus 402 to control one or more storage devices for storing information and instructions, such as a magnetic hard disk 407, and a removable media drive 408 (e.g., floppy disk drive, read-only compact disc drive, read/write compact disc drive, compact disc jukebox, tape drive, and removable magneto-optical drive). The storage devices may be added to the computer system 401 using an appropriate device interface (e.g., small computer system interface (SCSI), integrated device electronics (IDE), enhanced-IDE (E-IDE), direct memory access (DMA), or ultra-DMA).

The computer system 401 may also include special purpose logic devices 418, such as application specific integrated circuits (ASICs), full custom chips, configurable logic devices (e.g., simple programmable logic devices (SPLDs), complex programmable logic devices (CPLDs), field programmable gate arrays (FPGAs), etc.), etc., for performing special processing functions, such as signal processing, image processing, speech processing, voice recognition, infrared (IR) data communications, satellite communications transceiver functions, base station functions, data link resource scheduling functions, etc.

The computer system 401 may also include a display controller 409 coupled to the bus 402 to control a display 410, such as a cathode ray tube (CRT), liquid crystal display (LCD), active matrix display, plasma display, touch display, etc., for displaying or conveying information to a computer user. The computer system includes input devices, such as a keyboard 411 including alphanumeric and other keys and a pointing device 412, for interacting with a computer user and providing information to the processor 403. The pointing device 412, for example, may be a mouse, a trackball, a pointing stick, etc., or voice recognition processor, etc., for communicating direction information and command selections to the processor 403 and for controlling cursor movement on the display 410. In addition, a printer may provide printed listings of the data structures/information of the system shown in FIG. 1, or any other data stored and/or generated by the computer system 401.

The computer system 401 performs a portion or all of the processing steps of the invention in response to the processor 403 executing one or more sequences of one or more instructions contained in a memory, such as the main memory 404. Such instructions may be read into the main memory 404 from another computer readable medium, such as a hard disk 407 or a removable media drive 408. Execution of the arrangement of instructions contained in the main memory 404 causes the processor 403 to perform the process steps described herein. One or more processors in a multi-processing arrangement may also be employed to execute the sequences of instructions contained in main memory 404. In alternative embodiments, hard-wired circuitry may be used in place of or in combination with software instructions. Thus, embodiments are not limited to any specific combination of hardware circuitry and software.

Stored on any one or on a combination of computer readable media, the present invention includes software for controlling the computer system 401, for driving a device or devices for implementing the invention, and for enabling the computer system 401 to interact with a human user (e.g., users of the system 100 of FIG. 1, etc.). Such software may include, but is not limited to, device drivers, operating systems, development tools, and applications software. Such computer readable media further includes the computer program product of the present invention for performing all or a portion (if processing is distributed) of the processing performed in implementing the invention. Computer code devices of the present invention may be any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the present invention may be distributed for better performance, reliability, and/or cost.

The computer system 401 also includes a communication interface 413 coupled to the bus 402. The communication interface 413 provides a two-way data communication coupling to a network link 414 that is connected to, for example, a local area network (LAN) 415, or to another communications network 416 such as the Internet. For example, the communication interface 413 may be a digital subscriber line (DSL) card or modem, an integrated services digital network (ISDN) card, a cable modem, a telephone modem, etc., to provide a data communication connection to a corresponding type of telephone line. As another example, communication interface 413 may be a local area network (LAN) card (e.g., for Ethernet™, an Asynchronous Transfer Model (ATM) network, etc.), etc., to provide a data communication connection to a compatible LAN. Wireless links can also be implemented. In any such implementation, communication interface 413 sends and receives electrical, electromagnetic, or optical signals that carry digital data streams representing various types of information. Further, the communication interface 413 can include peripheral interface devices, such as a Universal Serial Bus (USB) interface, a PCMCIA (Personal Computer Memory Card International Association) interface, etc.

The network link 414 typically provides data communication through one or more networks to other data devices. For example, the network link 414 may provide a connection through local area network (LAN) 415 to a host computer 417, which has connectivity to a network 416 (e.g. a wide area network (WAN) or the global packet data communication network now commonly referred to as the “Internet”) or to data equipment operated by service provider. The local network 415 and network 416 both use electrical, electromagnetic, or optical signals to convey information and instructions. The signals through the various networks and the signals on network link 414 and through communication interface 413, which communicate digital data with computer system 401, are exemplary forms of carrier waves bearing the information and instructions.

The computer system 401 can send messages and receive data, including program code, through the network(s), network link 414, and communication interface 413. In the Internet example, a server (not shown) might transmit requested code belonging an application program for implementing an embodiment of the present invention through the network 416, LAN 415 and communication interface 413. The processor 403 may execute the transmitted code while being received and/or store the code in storage devices 407 or 408, or other non-volatile storage for later execution. In this manner, computer system 401 may obtain application code in the form of a carrier wave. With the system of FIG. 4, the present invention may be implemented on the Internet as a Web Server 401 performing one or more of the processes according to the present invention for one or more computers coupled to the Web server 401 through the network 416 coupled to the network link 414.

The term “computer readable medium” as used herein refers to any medium that participates in providing instructions to the processor 403 for execution. Such a medium may take many forms, including but not limited to, non-volatile media, volatile media, transmission media, etc. Non-volatile media include, for example, optical or magnetic disks, magneto-optical disks, etc., such as the hard disk 407 or the removable media drive 408. Volatile media include dynamic memory, etc., such as the main memory 404. Transmission media include coaxial cables, copper wire and fiber optics, including the wires that make up the bus 402. Transmission media can also take the form of acoustic, optical, or electromagnetic waves, such as those generated during radio frequency (RF) and infrared (IR) data communications. As stated above, the computer system 401 includes at least one computer readable medium or memory for holding instructions programmed according to the teachings of the invention and for containing data structures, tables, records, or other data described herein. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer connected to either of networks 415 and 416. In such a scenario, the remote computer loads the instructions into main memory and sends the instructions, for example, over a telephone line using a modem. A modem of a local computer system receives the data on the telephone line and uses an infrared transmitter to convert the data to an infrared signal and transmit the infrared signal to a portable computing device, such as a personal digital assistant (PDA), a laptop, an Internet appliance, etc. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

The present invention is applicable to the International Maritime Satellite (Inmarsat) [2] Early Entry System. The present invention is also applicable to any packet data applications employing a centralized data link scheduler, as will be appreciated by those skilled in the relevant art(s).

While the present invention has been described in connection with a number of embodiments and implementations, the present invention is not so limited but rather covers various modifications and equivalent arrangements, which fall within the purview of the appended claims.

### LIST OF REFERENCES

[1] The technical name of a frame of data transmitted between two peer entities in a communications network. The peer entities are located within the same layer of the protocol stack. Ethernet and Token Ring are examples of data link layer protocols. Many people neither use the term PDU nor the term frame, but call every unit of data traveling over a network a “packet.”

[2] (Inmarsat, London, inmarsat.org on the World Wide Web) Formerly International Maritime Satellite, it is an international organization founded in 1979 to provide global satellite communications to the maritime industry. Today, it provides satellite service to ships, planes, trains, offshore rigs and mobile phones. COMSAT is the U.S. signatory to Inmarsat.

[3] A type of TDMA transmission system developed by the University of Hawaii used for satellite and terrestrial radio links. In the traditional ALOHA system, packets are transmitted as required, and, like Ethernet's CSMA/CD method, collisions can occur. A “Slotted ALOHA” system triggers transmission starts by a clock and reduces the number of collisions.

[4] An enhancement to the GSM mobile communications system that supports data packets. GPRS enables continuous flows of IP data packets over the system for such applications as Web browsing and file transfer. GPRS differs from GSM's short messaging service (GSM-SMS), which is limited to messages of 160 bytes in length.

[5] e.g., as taught in etsi.org/bran/Summary.htm available on the World Wide Web.

[6] e.g., as taught in etsi.org/technicalactiv/tetra.htm available on the World Wide Web.

[7] The European implementation of the 3G wireless phone system. UMTS, which is part of IMT-2000, provides service in the 2 GHz band and offers global roaming and personalized features. Designed as an evolutionary system for GSM network operators, multimedia data rates up to 2 Mbps are expected using the W-CDMA technology. In the meantime, GPRS and EDGE are interim steps that will speed up wireless data for GSM.

[8] The Medium Access Control (MAC) sublayer of the data link layer that manages access to the physical layer (e.g., radio, etc.) resources by higher layer entities. MAC responsibilities may include arbitrating access to the physical layer between competing higher layer entities, building MAC PDUs for transfer over the data link and error detection and correction (e.g., forward error correction (FEC), etc.). The Radio Link Control (RLC) sublayer of the data link layer utilizes MAC services to transfer RLC blocks across the data link.

[9] The fundamental unit of information passed across any network utilizing Internet protocol. An IP datagram contains source and destination addresses along with data and a number of fields that define such things as the length of the datagram, the header checksum, and flags that indicate whether the datagram can be (or has been) fragmented.

[10] A digital cellular phone technology based on TDMA that is the predominant system in Europe, but is also used around the world. Developed in the 1980s, GSM was first deployed in seven European countries in 1992. Operating in the 900 MHz and 1.8 GHz bands in Europe and the 1.9 GHz PCS band in the U.S., GSM defines the entire cellular system, not just the air interface (TDMA, CDMA, etc.).

[11] The worldwide voice telephone network. Once only an analog system, the heart of most telephone networks today is all digital. In the U.S., most of the remaining analog lines are the ones from your house or office to the telephone company's central office (CO).

[12] An international telecommunications standard for providing a digital service from the customer's premises to the dial-up telephone network. ISDN turns one existing wire pair into two channels and four wire pairs into 23 channels for the delivery of voice, data or video. Unlike an analog modem, which converts digital signals into an equivalency in audio frequencies, ISDN deals only with digital transmission. Analog telephones and fax machines are used over ISDN lines, but their signals are converted into digital by the ISDN modem.

[13] The network that connects a customer's ADSL transceiver (ATU-R) to the Service Modules (PCs, routers, set-top boxes, etc.).

What is claimed is:

1. A computer-implemented method for demanding a data link resource in a communications network, comprising:
calculating an unsatisfied demand (UD) value for the data link resource at a terminal; and
transmitting the calculated UD value over the data link from the terminal to a base station at a time uncorrelated with a time at which new demand for the data link resource is detected by the terminal.

2. The method of claim 1, wherein the calculating step comprises calculating the UD value based on the following equation:
UD=NUM_RLC_BLK_UNSENT+NUM_RLC_BLK_NACK,
where NUM_RLC_BLK_UNSENT is a number of radio link control (RLC) blocks not yet sent and NUM_RLC_BLK_NACK is a number of RLC blocks negatively acknowledged by the base station.

3. The method of claim 2, wherein the calculating step comprises setting a UD_MAX value as a maximum UD value that can be conveyed by a UD field of a medium access control (MAC) header.

4. The method of claim 3, wherein the calculating step comprises setting the UD value to the UD_MAX value if the UD value is greater than the UD_MAX value.

5. The method of claim 2, wherein the transmitting step comprises transmitting the calculated UD value on every transmission from the terminal to the base station over the data link.

6. The method of claim 2, wherein the transmitting step comprises transmitting the calculated UD value on every transmission in which data is transmitted from the terminal to the base station over the data link.

7. A computer-implemented method for demanding a data link resource in a communications network, comprising:
calculating an unsatisfied demand (UD) value for the data link resource at a terminal, based on the following equation:
UD=NUM_RLC_BLK_UNSENT+NUM_RLC_BLK_NACK,
where NUM_RLC_BLK_UNSENT is a number of radio link control (RLC) blocks not yet sent and NUM_RLC_BLK_NACK is a number of RLC blocks negatively acknowledged by a base station; and
transmitting the calculated UD value over the data link from the terminal to the base station.

8. The method of claim 7, wherein the transmitting step comprises transmitting the calculated UD value over the data link from the terminal to the base station at a time uncorrelated with a time at which new demand for the data link resource is detected by the terminal.

9. The method of claim 7, wherein the calculating step comprises setting a UD_MAX value as a maximum UD value that can be conveyed by a UD field of a medium access control (MAC) header.

10. The method of claim 9, wherein the calculating step comprises setting the UD value to the UD_MAX value if the UD value is greater than the UD_MAX value.

11. The method of claim 7, wherein the transmitting step comprises transmitting the calculated UD value on every transmission from the terminal to the base station over the data link.

12. The method of claim 7, wherein the transmitting step comprises transmitting the calculated UD value on every transmission in which data is transmitted from the terminal to the base station over the data link.

13. A computer-implemented method for interpreting a demand for a data link resource in a communications network, comprising:
calculating at a terminal an unsatisfied demand (UD) value for the data link resource based on the following equation:
UD=NUM_RLC_BLK_UNSENT+NUM_RLC_BLK_NACK,
where NUM_RLC_BLK_UNSENT is a number of radio link control (RLC) blocks not yet sent and NUM_RLC_BLK_NACK is a number of RLC blocks negatively acknowledged by a base station;
transmitting the calculated UD value over the data link from the terminal to the base station;
receiving the UD value for the data link resource from the terminal at the base station over the data link;
calculating an imputed unsatisfied demand (IUD) value at the base station based on the received UD value and existing data link resources already allocated to the terminal; and
transmitting the calculated ID value to a data link resource scheduler.

14. The method of claim 13, further comprising initializing the IUD value to the UD value received when a new uplink flow over the data link is first established.

15. The method of claim 14, wherein the initializing step comprises servicing the new uplink flow in demand mode.

16. The method of claim 15, further comprising decrementing the IUD value whenever an uplink slot is allocated for the flow in the demand mode.

17. The method of claim 16, further comprising transitioning the demand mode to a polled mode when the IUD value is decremented to zero.

18. The method of claim 15, further comprising incrementing the IUD value whenever the UD value received indicates that the uplink flow requires resources of the data link that have not already been handled by previously allocated uplink slot assignments.

19. The method of claim 15, further comprising transitioning the flow from a polled mode to the demand mode when the IUD value is incremented to a value greater than zero.

20. The method of claim 19, further comprising servicing the flow in the demand mode.

21. The method of claim 13, wherein the step of calculating the IUD value comprises prospectively raising the IUD value at the base station based on a number of radio link control (RLC) blocks negatively acknowledged by the base station.

22. The method of claim 21, wherein the raising step comprises setting the IUD value at the base station to the number of the RLC blocks negatively acknowledged by the base station.

23. The method of claim 22, wherein the setting step comprises transitioning an uplink flow on the data link from a polled mode to a demand mode.

24. The method of claim 13, wherein the step of transmitting the calculated UD value comprises transmitting the calculated UD value over the data link from the terminal to the base station at a time uncorrelated with a time at which new demand for the data link resource is detected by the terminal.

25. The method of claim 13, wherein the step of transmitting the calculated UD value comprises transmitting the calculated UD value on every transmission from the terminal to the base station over the data link.

26. The method of claim 13, wherein the step of transmitting the calculated UD value comprises transmitting the calculated UD value on every transmission in which data is transmitted from the terminal to the base station over the data link.

27. A computer-implemented method for performing bandwidth-on-demand signaling in a communications network, comprising:
calculating at a terminal an unsatisfied demand (UD) value for a data link resource based on the following equation:
UD=NUM_RLC_BLK_UNSENT+NUM_RLC_BLK_NACK,
where NUM_RLC_BLK_UNSENT is a number of radio link control (RLC) blocks not yet sent and NUM_RLC_BLK_NACK is a number of RLC blocks negatively acknowledged by a base station;
transmitting the calculated UD value over the data link from the terminal to the base station at a time uncorrelated with a time at which new demand for the data link resource is detected by the terminal;
receiving the UD value for the data link resource from the terminal at the base station over the data link;
calculating an imputed unsatisfied demand (IUD) value at the base station based on the received UD value and existing data link resources already allocated to the terminal; and
transmitting the calculated IUD value to a data link resource scheduler.

28. The method of claim 27, wherein the step of transmitting the calculated UD value comprises transmitting the calculated UD value on every transmission from the terminal to the base station over the data link.

29. The method of claim 27, wherein the step of transmitting the calculated UD value comprises transmitting the calculated UD value on every transmission in which data is transmitted from the terminal to the base station over the data link.

30. A computer-readable medium carrying one or more sequences of one or more instructions, the one or more sequences of one or more instructions including instructions which, when executed by one or more processors, cause the one or more processors to perform the steps recited in any one of claims 1-29.

31. A system configured to perform the steps recited in any one of claims 1-29.

32. An apparatus for demanding a data link resource in a communications network, comprising:
means for calculating an unsatisfied demand (UD) value for the data link resource; and
means for transmitting the calculated UD value over the data link at a time uncorrelated with a time at which new demand for the data link resource is detected.

33. An apparatus for demanding a data link resource in a communications network, comprising:
means for calculating an unsatisfied demand (UD) value for the data link resource, based on the following equation:
UD=NUM_RLC_BLK_UNSENT+NUM_RLC_BLK_NACK,
where NUM_RLC_BLK_UNSENT is a number of radio link control (RLC) blocks not yet sent and NUM_RLC_BLK_NACK is a number of RLC blocks negatively acknowledged; and
means for transmitting the calculated UD value over the data link.

34. A system for interpreting a demand for a data link resource in a communications network, comprising:
means for calculating at a terminal an unsatisfied demand (UD) value for the data link resource based on the following equation:
UD=NUM_RLC_BLK_UNSENT+NUM_RLC_BLK_NACK,
where NUM_RLC_BLK_UNSENT is a number of radio link control (RLC) blocks not yet sent and NUM_RLC_BLK_NACK is a number of RLC blocks negatively acknowledged;
means for transmitting the calculated UD value over the data link;
means for receiving the UD value for the data link resource over the data link;
means for calculating an imputed unsatisfied demand (IUD) value based on the received UD value and existing data link resources already allocated; and
means for transmitting the calculated IUD value to a data link resource scheduling means.

35. A system for performing bandwidth-on-demand signaling in a communications network, comprising:
means for calculating an unsatisfied demand (UD) value for a data link resource based on the following equation:
UD=NUM_RLC_BLK_UNSENT+NUM_RLC_BLK_NACK,
where NUM_RLC_BLK_UNSENT is a number of radio link control (RLC) blocks not yet sent and NUM_RLC_BLK_NACK is a number of RLC blocks negatively acknowledged;
means for transmitting the calculated UD value over the data link at a time uncorrelated with a time at which new demand for the data link resource is detected;
means for receiving the UD value for the data link resource over the data link;
means for calculating an imputed unsatisfied demand (IUD) value based on the received UD value and existing data link resources already allocated; and
means for transmitting the calculated IUD value to a data link resource scheduling means.
